(19) United States
(12) Patent Application Publication
(10) Pub. No.: US 2024/0128531 A1
(43) Pub. Date: Apr. 18, 2024

(54) METHOD FOR RECYCLING ALL TYPES OF LITHIUM BATTERIES

(71) Applicant: Cleanaway Company Limited, Kaohsiung City (TW)

(72) Inventors: CHIH-HUANG LAI, Hsinchu City (TW); HSIN-FANG CHANG, Hsinchu City (TW); TZU-MIN CHENG, Hsinchu City (TW); YUNG-FA YANG, Kaohsiung City (TW); TSUNG-TIEN CHEN, Kaohsiung City (TW); ZHENG-YU CHENG, Hsinchu City (TW); CHI-YUNG CHANG, Kaohsiung City (TW)

(73) Assignee: Cleanaway Company Limited, Kaohsiung City (TW)

(21) Appl. No.: 18/473,263

(22) Filed: Sep. 24, 2023

(30) Foreign Application Priority Data
Oct. 12, 2022 (TW) 111138678

(51) Int. Cl. H01M 10/54; C01B 25/37; C01D 15/08; C01F 7/34; C01G 45/02; C01G 51/04; C01G 53/04

(52) U.S. Cl. CPC H01M 10/54; C01B 25/375; C01D 15/08; C01F 7/34; C01G 45/02; C01G 51/04; C01G 53/04; C01P 2006/80

(57) ABSTRACT

The present disclosure discloses a method for recycling all types of lithium batteries. First, the lithium battery waste is acid-leached to obtain a solution containing most of metal ions. After filtering, the solution is separated from the remaining solids, and then the obtained solution is subjected to separate precipitation many times. After separately adjusting the pH value of the solution many times, adding precipitants with a high selectivity ratio, and matching with filtration and separation reaction, all ions in the lithium battery waste are sequentially precipitated in forms of iron phosphate (FePO₄), aluminum hydroxide (Al(OH)₃), manganese oxide (MnO₂), dicobalt trioxide (cobalt oxide, Co₂O₃), nickel hydroxide (Ni(OH)₂), and lithium carbonate (Li₂CO₃).

### REFERENCE TO RELATED APPLICATIONS

The present application is based on, and claims priority from, Taiwan application number 111138678, filed Oct. 12, 2022, the disclosure of which is hereby incorporated by reference herein in its entirety.

### BACKGROUND OF THE INVENTION

### Field of the Invention

The present disclosure belongs to the field of lithium battery waste recycling, in particular to a method for simultaneously recycling all types of lithium batteries using hydrometallurgy.

### Description of the Prior Art

Lithium batteries are common energy storage units. With the vigorous development of scientific and technological industry and more attention to green energy industry, the use of electric vehicles and portable electronic devices is also increasing, and the demand for lithium batteries is increasing day by day. Therefore, the recovery and reuse of waste lithium batteries has become an urgent issue to be faced at present. Due to the various types of metals contained in lithium batteries, their usage specifications are not the same, resulting in difficulties and limitations in recycling and sorting.

Among the existing lithium battery types, the following five are the most common at present, namely lithium iron phosphate (LFP), lithium nickel cobalt manganese oxide (NCM), lithium nickel cobalt aluminium oxide (NCA), lithium cobalt oxide (LCO), lithium manganese oxide (LMO). In the related art which is intended to reduce the complexity of lithium battery recycling and improve the purity of recovered products. Therefore, most of the recycling processes are designed for a single type of lithium battery waste, and there is no technology that can simultaneously recycle the above five types of battery waste.

In addition, in the related art, elements such as iron, phosphorus, aluminum, lithium, and the like in lithium battery waste can be easily separated by adding an aqueous precipitant and adjusting the pH value. However, nickel, cobalt, and manganese are in similar positions in the periodic table of the elements and have similar physical and chemical properties. Therefore, it is quite difficult to separate them by an all-water-phase technology. A common method is to use more than one oil-phase extractant with a high selectivity ratio to separate and extract one or more of nickel, cobalt, and manganese metal ions. However, the oil-phase extractants are often costly and complex, which makes commercialization difficult.

It can be seen from the above that in the field of lithium battery recycling, it is the goal of efforts and research by all involved to seek technologies and solutions that can simultaneously recycle all types of lithium battery waste and reduce the complexity of the recycling process and the overall cost to achieve commercialization.

In view of the various shortcomings of the above-mentioned related art, the inventor is eager to improve and innovate the related art, and successfully researches and develops a method of the present invention for recycling all types of lithium batteries.

### SUMMARY OF THE INVENTION

The present disclosure provides a method for recycling all types of lithium batteries, which is a high-efficiency all-water-phase wet recycling process for all types of lithium battery waste.

The present disclosure provides a method for recycling all types of lithium batteries, including:
placing lithium battery waste and deionized water in a water bath with a temperature of 60° C.-90° C., and slowly adding an acid leaching solution with stirring at a stirring speed of 300-500 rpm to react for 1-5 h;
filtering the reaction solution to obtain a first separated liquid and a first separated solid, where the first separated liquid includes one of or a combination of more of lithium ion, nickel ion, cobalt ion, manganese ion, iron ion, aluminum ion and phosphorus ion;
at room temperature, adding 1-5M sodium hydroxide to adjust the pH value of the first separated liquid to 2-4, and stirring the solution at a stirring speed of 300-500 rpm for 1-24 h to have a precipitation reaction;
filtering the reaction solution to obtain a second separated liquid and a second separated solid, where the second separated liquid includes one of or a combination of more of lithium ion, nickel ion, cobalt ion, manganese ion, and aluminum ion; and washing the second separated solid with deionized water, and drying the water up;
at room temperature, adding 1-5M sodium hydroxide to adjust the pH value of the second separated liquid to 4-6, and stirring the solution at a stirring speed of 300-500 rpm for 1-24 h to have a precipitation reaction;
filtering the reaction solution to obtain a third separated liquid and a third separated solid, where the third separated liquid includes one of or a combination of more of lithium ion, nickel ion, cobalt ion and manganese ion; and washing the third separated solid with deionized water, and drying the water up;
at room temperature, adding 1-5M aqueous sulfuric acid solution to adjust the pH value of the third separated liquid to 1.5-3, and slowly adding potassium permanganate and stirring the solution at a stirring speed of 300-500 rpm for 1-24 h to have a precipitation reaction;
filtering the reaction solution to obtain a fourth separated liquid and a fourth separated solid, where the fourth separated liquid includes one of or a combination of more of lithium ion, nickel ion and cobalt ion; and washing the fourth separated solid with deionized water and drying the water up;
at room temperature, adding 1-5M sodium hydroxide to adjust the pH value of the fourth separated liquid to 2-4, and slowly adding sodium hypochlorite, and stirring the solution at a stirring speed of 300-500 rpm for 1-24 h to have a precipitation reaction;
filtering the reaction solution to obtain a fifth separated liquid and a fifth separated solid, where the fifth separated liquid includes one or two of lithium ion and nickel ion; and washing the fifth separated solid with deionized water and drying the water up;
at room temperature, adding 1-5M sodium hydroxide to adjust the pH value of the fifth separated liquid to 9-12, and stirring the solution at a stirring speed of 300-500 rpm for 1-24 h to have a precipitation reaction;
filtering the reaction solution to obtain a sixth separated liquid and a sixth separated solid, where the sixth separated liquid includes lithium ion; and washing the sixth separated solid with deionized water and drying the water up;
at room temperature, adding saturated sodium hydroxide to adjust the pH value of the sixth separated liquid to 12-14, and heating the solution till boiling to reduce the amount of the solution by half, and adding saturated sodium carbonate during the boiling process of the solution; and
filtering the reaction solution to obtain a seventh separated liquid and a seventh separated solid; and washing the seventh separated solid with deionized water and drying the water up.

The acid leaching solution is one of or a combination of more of hydrochloric acid, nitric acid and sulfuric acid.

The acid leaching solution is prepared from 0.5-3.5M sulfuric acid and hydrogen peroxide with a concentration (in volume percent) of less than 8 v/v.

The first separated solid is added into the next batch of lithium battery waste to react again.

The second separated solid is iron phosphate.

The third separated solid is aluminum hydroxide.

The fourth separated solid is manganese oxide.

The fifth separated solid is cobalt oxide.

The sixth separated solid is nickel hydroxide.

The seventh separated solid is lithium carbonate.

Compared with the related art, the method for recycling all types of lithium batteries of the present disclosure has the biggest difference in that it can simultaneously recycle lithium battery waste including lithium iron phosphate (LFP), lithium cobalt oxide (LCO), lithium manganese oxide (LMO), lithium nickel cobalt manganese oxide (NCM), and lithium nickel cobalt aluminium oxide (NCA), thereby effectively ameliorating the problem of recycling a single metal oxide in a single process in the related art. In addition, the method for recycling all types of lithium batteries of the present application utilizes the all-water phase hydrometallurgy to replace the step of separating oxides of nickel, cobalt, and manganese with an oil-phase extract in the related art, thereby reducing the overall cost. In addition, the all-water phase recycling process is more conducive to the integration of continuous recycling process, which is further conducive to the commercial transfer of technology.

### BRIEF DESCRIPTION OF THE DRAWINGS

The techniques of present invention would be more understandable from the detailed description given herein below and the accompanying figures are provided for better illustration, and thus description and figures are not limitative for present invention, and wherein:

FIG. 1A is a flow chart of a method for recycling all types of lithium batteries according to the present disclosure; and

FIG. 1B is a flow chart of a method for recycling all types of lithium batteries according to the present disclosure.

### DETAILED DESCRIPTION OF THE INVENTION

In this embodiment, analytical-grade chemicals are selected to reduce the contamination of impurities, and all aqueous solutions are formulated with deionized water. After many experiments and comparison with previous technologies, it is found that although hydrochloric acid has the highest leaching rate for lithium battery waste, chlorine gas that may be generated during the acid leaching step is likely to cause damage to equipment and endanger the safety of people implementing the step. Therefore, this embodiment further selects sulfuric acid with a high number of leaching times. The acid leaching solution described in this disclosure is not limited to sulfuric acid, any that can convert metal into an ionic state fall within the scope of the acid leaching solution described in the present disclosure, such as hydrochloric acid, nitric acid, sulfuric acid, etc. In addition, the acid leaching solution can also be matched with hydrogen peroxide for adjustment, or other solutions with reducing functions, such as sodium thiosulfate (Na₂S₂O₃), sodium bisulfate (NaHSO₄), etc., to obtain a solution containing most of the metal ions. After filtering, the solution is separated from the residual solids, and the solution obtained above is subjected to separate precipitation many times. The filtered and separated solution is subjected to pH value adjustment and addition of precipitants with a high selectivity ratio and solutions and precipitates obtained after the completion of filtration and separation reaction are matched many times. All ions in the lithium battery waste are sequentially precipitated in forms of iron phosphate (FePO₄), aluminum hydroxide (Al(OH)₃), manganese oxide (MnO₂), dicobalt trioxide (cobalt oxide, Co₂O₃), nickel hydroxide (Ni(OH)₂), and lithium carbonate (Li₂CO₃). The residual solid is composed of undissolved carbon and a small amount of undissolved cathode active materials. In order to maximize the reuse of valuable metals, the residual solid will be added to the next batch of raw materials for re-leaching.

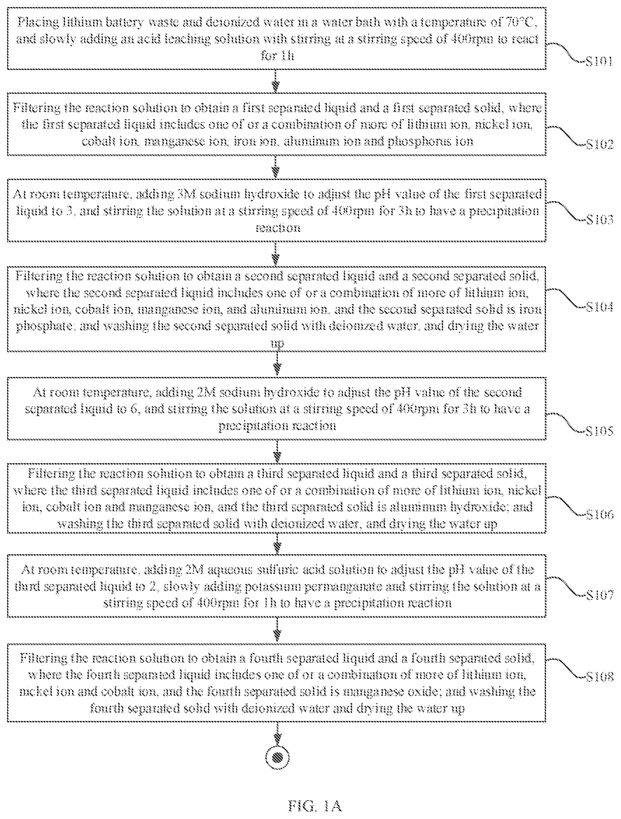

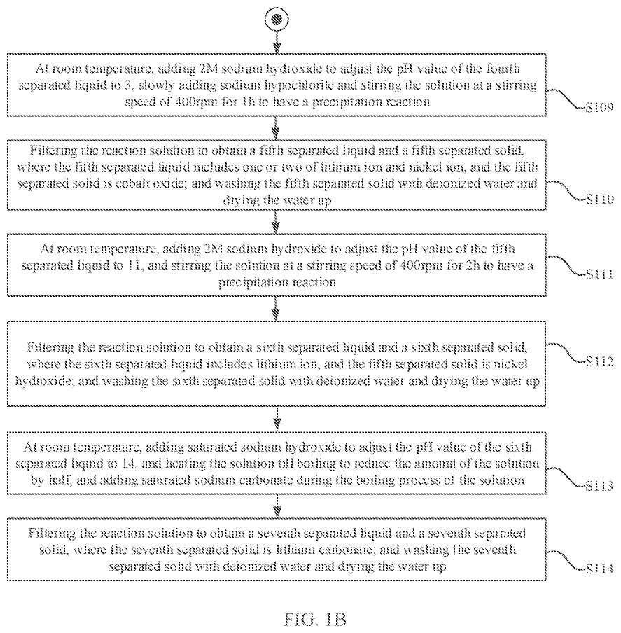

Referring to FIGS. 1A and 1B, the flow chart of a method for recycling all types of lithium batteries according to the present disclosure is shown. The method includes the following steps:
S101, placing lithium battery waste and deionized water in a water bath with a temperature of 70° C., and slowly adding an acid leaching solution with stirring at a stirring speed of 400 rpm to react for 1 h;
S102, filtering the reaction solution to obtain a first separated liquid and a first separated solid, where the first separated liquid includes one of or a combination of more of lithium ion, nickel ion, cobalt ion, manganese ion, iron ion, aluminum ion and phosphorus ion;
S103, at room temperature, adding 3M sodium hydroxide to adjust the pH value of the first separated liquid to 3, and stirring the solution at a stirring speed of 400 rpm for 3 h to have a precipitation reaction;
S104, filtering the reaction solution to obtain a second separated liquid and a second separated solid, where the second separated liquid includes one of or a combination of more of lithium ion, nickel ion, cobalt ion, manganese ion, and aluminum ion, and the second separated solid is iron phosphate; and washing the second separated solid with deionized water, and drying the water up;
S105, at room temperature, adding 2M sodium hydroxide to adjust the pH value of the second separated liquid to 6, and stirring the solution at a stirring speed of 400 rpm for 3 h to have a precipitation reaction;
S106, filtering the reaction solution to obtain a third separated liquid and a third separated solid, where the third separated liquid includes one of or a combination of more of lithium ion, nickel ion, cobalt ion and manganese ion, and the third separated solid is aluminum hydroxide; and washing the third separated solid with deionized water, and drying the water up;
S107, at room temperature, adding 2M aqueous sulfuric acid solution to adjust the pH value of the third separated liquid to 2, slowly adding potassium permanganate and stirring the solution at a stirring speed of 400 rpm for 1 h to have a precipitation reaction;
S108, filtering the reaction solution to obtain a fourth separated liquid and a fourth separated solid, where the fourth separated liquid includes one of or a combination of more of lithium ion, nickel ion and cobalt ion, and the fourth separated solid is manganese oxide; and washing the fourth separated solid with deionized water and drying the water up;
S109, at room temperature, adding 2M sodium hydroxide to adjust the pH value of the fourth separated liquid to 3, slowly adding sodium hypochlorite and stirring the solution at a stirring speed of 400 rpm for 1 h to have a precipitation reaction;
S110, filtering the reaction solution to obtain a fifth separated liquid and a fifth separated solid, where the fifth separated liquid includes one or two of lithium ion and nickel ion, and the fifth separated solid is cobalt oxide; and washing the fifth separated solid with deionized water and drying the water up;
S111, at room temperature, adding 2M sodium hydroxide to adjust the pH value of the fifth separated liquid to 11, and stirring the solution at a stirring speed of 400 rpm for 2 h to have a precipitation reaction;
S112, filtering the reaction solution to obtain a sixth separated liquid and a sixth separated solid, where the sixth separated liquid includes lithium ion, and the fifth separated solid is nickel hydroxide; and washing the sixth separated solid with deionized water and drying the water up;
S113, at room temperature, adding saturated sodium hydroxide to adjust the pH value of the sixth separated liquid to 14, and heating the solution till boiling to reduce the amount of the solution by half, and adding saturated sodium carbonate during the boiling process of the solution; and
S114, filtering the reaction solution to obtain a seventh separated liquid and a seventh separated solid, where the seventh separated solid is lithium carbonate; and washing the seventh separated solid with deionized water and drying the water up.

The steps S101 to S114 in the above embodiment provide the best parameters of the present disclosure, but the present disclosure is not limited thereto, and any combination of parameters that can achieve the above effects falls within the spirit and scope of the present disclosure.

The lithium battery waste refers to the waste containing cathode and anode active materials of discarded lithium batteries.

The acid leaching solution in step S101 is prepared from sulfuric acid and hydrogen peroxide, where the concentration of sulfuric acid ranges from 0.5M to 3.5M and is most preferably 2M, and the amount of hydrogen peroxide added is less than 8 v/v, most preferably 6 v/v. In addition, the combination of sulfuric acid and hydrogen peroxide in this embodiment can be further any combination of sulfuric acid with a concentration of 0.5M, 1M, 1.5M, 2M, 2.5M, 3M, or 3.5M and hydrogen peroxide added in amount of 2 v/v, 4 v/v, or 6 v/v.

The first separated solid in step S102 includes lithium iron phosphate (LFP), lithium nickel cobalt manganese oxide (NCM), lithium nickel cobalt aluminium oxide (NCA), lithium cobalt oxide (LCO), lithium manganese oxide (LMO) and insoluble carbon anode active materials. In order to maximize the recovery rate, the first separated solid will be put into the next batch of lithium battery waste to react again.

The second separated solid to the seventh separated solid are washed with deionized water and then dried.

In step S107, the manganese ion (Mn²⁺) in the third separated liquid is precipitated in the form of manganese oxide, where the molar ratio of Mn²⁺/KMnO₄ is about 1-3, most preferably 1.5.

In step S109, cobalt ion (Co²⁺) in the fourth separated liquid is precipitated in the form of cobalt oxide, where the molar ratio of NaClO/Co²⁺ is about 2.5-6, most preferably 3.

In step S113, the molar ratio of Li⁺/Na₂CO₃ is about 0.5-1, most preferably 0.6.

As shown in table 1 below, it is the EDS analysis of this embodiment.

TABLE 1

| Room temperature | Purity (Atomatic Percent, at %) | | | | |
|---|---|---|---|---|---|
| Oxide | FePO₄ | Al(OH)₃ | MnO₂ | Co₂O₃ | Ni(OH)₂ |
| Reaction time (h) | 2 | 2 | 1 | 1 | 2 |
| pH value | 3 | 6 | 2 | 3 | 11 |
| Precipitant | NaOH | NaOH | KMnO₄ | NaClO | NaOH |
| Al | 0.06 | 14.09 | 0.08 | 0.06 | 0.37 |
| P | 50.03 | 43.58 | 2.25 | 2.09 | 1.34 |
| Mn | 0.43 | 19.81 | 91.93 | 0.15 | 0.31 |
| Fe | 48.90 | 11.65 | 0.69 | 0.04 | 0 |
| Co | 0.49 | 6.53 | 4.17 | 98.06 | 7.00 |
| Ni | 0.10 | 4.35 | 0.87 | 0 | 90.98 |

It can be seen from the above that the method for recycling all types of lithium batteries of the present disclosure can completely separate elements such as phosphorus, iron, manganese, cobalt, nickel and the like in lithium battery waste. It can be further seen that the target purities of manganese oxide, cobalt oxide, nickel hydroxide and other high-valent oxides are all greater than 90%. Moreover, as shown in table 2 below which involves the seventh separated liquid and the seventh separated solid that have not been separated in step S114 of the present disclosure, where the contents of aluminum, phosphorus, manganese, iron, cobalt and nickel, other than lithium carbonate (Li₂CO₃), are all very low, so it can be further estimated that the purity of lithium carbonate is greater than 90%.

TABLE 2

| | C | O | Al | P | S | Mn | Fe | Co | Ni |
|---|---|---|---|---|---|---|---|---|---|
| Purity (Atomatic | 25.41 | 65.16 | 0 | 0.09 | 8.9 | 0.32 | 0.01 | 0.04 | 0 |
| Percent, at %) | | | | | | | | | |

The purity of the aluminum hydroxide described above is relatively low because the market share of NCA in the current related art is not high and the content of aluminum in NCA is low. The common ratio of Ni:Co:Al in commercial lithium batteries is 8:1.5:0.5, so that manganese can be replaced with a small amount of aluminum. As a result, the material becomes more stable, thereby improving the cycle performance of the material.

The steps in the method for recovering all types of lithium batteries of the present disclosure are not limited to the order and times of the above embodiments. If only two types of cathode oxides such as lithium iron phosphate (LFP) and lithium manganese oxide (LMO) need to be collected, the method can be adjusted to only implement the precipitation steps of iron phosphate, manganese oxide and lithium carbonate.

In addition, the method for recycling all types of lithium batteries of the present disclosure can be further integrated into a continuous production line. For example, an automatic pH controller can be used to adjust the pH value, a quantitative pump can be used to control the addition of precipitants, a separation device such as a centrifuge can be replaced with a suction filter unit, and a peristaltic pump can be used in solution transfer. Therefore, compared with the existing technology for recycling lithium battery waste, the method for recycling all types of lithium batteries of the present disclosure has considerable development potential and industrial application value.

The above are only preferred embodiments of the present disclosure, and are not intended to limit the implementation scope of the present disclosure. Any modification or equivalent replacement of the present disclosure, without departing from the spirit and scope of the present disclosure, shall be covered by the scope of the patent disclosure.

What is claimed is:

1. A method for recycling all types of lithium batteries, comprising:
placing lithium battery waste and deionized water in a water bath, and slowly adding an acid leaching solution with stirring to react;
filtering the reaction solution to obtain a first separated liquid and a first separated solid, wherein the first separated liquid comprises one or a combination of more of lithium ion, nickel ion, cobalt ion, manganese ion, iron ion, aluminum ion and phosphorus ion;
at room temperature, adding sodium hydroxide to adjust the pH value of the first separated liquid to 2-4, and stirring the solution to have a precipitation reaction;
filtering the reaction solution to obtain a second separated liquid and a second separated solid, wherein the second separated liquid comprises one of or a combination of more of lithium ion, nickel ion, cobalt ion, manganese ion, and aluminum ion; and washing the second separated solid with deionized water, and drying the water up;
at room temperature, adding sodium hydroxide to adjust the pH value of the second separated liquid to 4-6, and stirring the solution to have a precipitation reaction;
filtering the reaction solution to obtain a third separated liquid and a third separated solid, wherein the third separated liquid comprises one of or a combination of more of lithium ion, nickel ion, cobalt ion and manganese ion; and washing the third separated solid with deionized water, and drying the water up;
at room temperature, adding an aqueous sulfuric acid solution to adjust the pH value of the third separated liquid to 1.5-3, and slowly adding potassium permanganate and stirring the solution to have a precipitation reaction;
filtering the reaction solution to obtain a fourth separated liquid and a fourth separated solid, wherein the fourth separated liquid comprises one of or a combination of more of lithium ion, nickel ion and cobalt ion; and washing the fourth separated solid with deionized water and drying the water up;
at room temperature, adding sodium hydroxide to adjust the pH value of the fourth separated liquid to 2-4, and slowly adding sodium hypochlorite and stirring the solution to have a precipitation reaction;
filtering the reaction solution to obtain a fifth separated liquid and a fifth separated solid, wherein the fifth separated liquid comprises one or two of lithium ion and nickel ion; and washing the fifth separated solid with deionized water and drying the water up;
at room temperature, adding sodium hydroxide to adjust the pH value of the fifth separated liquid to 9-12, and stirring the solution to have a precipitation reaction;
filtering the reaction solution to obtain a sixth separated liquid and a sixth separated solid, wherein the sixth separated liquid comprises lithium ion; and washing the sixth separated solid with deionized water and drying the water up;
at room temperature, adding saturated sodium hydroxide to adjust the pH value of the sixth separated liquid to 12-14, and heating the solution till boiling to reduce the amount of the solution by half, and adding saturated sodium carbonate during the boiling process of the solution; and
filtering the reaction solution to obtain a seventh separated liquid and a seventh separated solid; and washing the seventh separated solid with deionized water and drying the water up.

2. The method for recycling all types of lithium batteries according to claim 1, wherein the acid leaching solution is one of or a combination of more of hydrochloric acid, nitric acid and sulfuric acid.

3. The method for recycling all types of lithium batteries according to claim 1, wherein the acid leaching solution is prepared from 0.5-3.5M sulfuric acid and hydrogen peroxide with a concentration (in volume percent) of less than 8 v/v.

4. The method for recycling all types of lithium batteries according to claim 1, wherein the first separated solid is added into the next batch of lithium battery waste to react again.

5. The method for recycling all types of lithium batteries according to claim 1, wherein the second separated solid is iron phosphate.

6. The method for recycling all types of lithium batteries according to claim 1, wherein the third separated solid is aluminum hydroxide.

7. The method for recycling all types of lithium batteries according to claim 1, wherein the fourth separated solid is manganese oxide.

8. The method for recycling all types of lithium batteries according to claim 1, wherein the fifth separated solid is cobalt oxide.

9. The method for recycling all types of lithium batteries according to claim 1, wherein the sixth separated solid is nickel hydroxide.

10. The method for recycling all types of lithium batteries according to claim 1, wherein the seventh separated solid is lithium carbonate.
